(19) United States
(12) Patent Application Publication
(10) Pub. No.: US 2019/0019428 A1
(43) Pub. Date: Jan. 17, 2019

(54) Computerized System And Method For Providing Competency-Based Learning

(71) Applicant: eLearning Innovation, LLC, Milford, NH (US)

(72) Inventors: Laurie Pulido, Hampton (AU); Eric Eberhardt, Blairsville, GA (US); Daniel Del Rio, Seminole, FL (US); Michael McCrary, Somerville, MA (US)

(21) Appl. No.: 16/135,850

(22) Filed: Sep. 19, 2018

Related U.S. Application Data
(63) Continuation of application No. 14/947,318, filed on Nov. 20, 2015, now abandoned.
(60) Provisional application No. 62/082,757, filed on Nov. 21, 2014.

(51) Int. Cl. G09B 7/00; G09B 7/02; G06F 17/30; G09B 5/02

(52) U.S. Cl. CPC G09B 7/00; G09B 7/02; G09B 5/02; G06F 17/30864

(57) ABSTRACT

A system and method for use in the field of online learning to design, deliver, measure, track, and manage educational courses and programs. The system and method serve to improve the quality and consistency of online course delivery and provide critical analytics to administrators. The system and method are implemented as an integrated suite of web applications configured and designed to allow a user of a computerized system including at least one computer processor operating such web applications to design, deliver, measure, and manage educational content. A number of necessary functionalities in this process, including source control service storage, content storage and service, curriculum mapping, assessment/rubric generation, stylized content experience for learners and instructors (learning path), and data analytics for learners, instructors, and administrators.

### CROSS-REFERENCE TO RELATED APPLICATIONS

This application is a continuation of pending U.S. patent application Ser. No. 14/947,318 filed Nov. 20, 2015, which in turn claims the benefit, under 35 USC § 119 (e), of U.S. Provisional Patent Application No. 62/082,757 titled “Computerized System and Method For Providing Competency-Based Learning”, which was filed on Nov. 21, 2014. All prior applications are herein incorporated by reference.

### FIELD OF THE INVENTION

The present invention is related to the field of online learning and more particularly, to an online learning system and method which is configured to design, deliver, measure, track, and manage educational courses and programs.

### BACKGROUND OF THE INVENTION

Since the advent of the Internet, there has been a consistent movement to capitalize on utilization of the “online” space to make learning more efficient. This online learning could apply to the public school system, higher education, or private corporate trainings. In fact, a specific field of technology, dubbed “educational technology,” has emerged to meet the needs and requirements for online learning.

There are a variety of educational technology products on the market already. The most prominent are Learning Management Systems (LMS), which provide an online classroom environment in which students interact with professors and each other; take tests; and submit assignments. Most LMSs also include some sort of content management system so that course content can be uploaded and stored virtually. In short, LMSs allow for the management of content and its delivery to learners and instructors of those learners.

A notable advantage to delivering educational content in an online environment is the ability to measure and track data points. The exact measures can vary, whether they are around learner retention, graduation rates, average grades, or other metrics. Irrespective of what the exact measures are, however, the measurement of these data points provides institutions/companies with the ability to assess the effectiveness and quality of their educational system. It can also assist them in pinpointing areas for improvement. LMSs provide various ways to measure these data points. Alternatively, data measurement and presentation can be done through add-ons to the LMS or even in some instances independent software.

Unfortunately, however, the current state-of-the-art online learning management systems, with or without independent software, do not allow users (the learning or sponsoring institution) to establish holistic learning outcomes for students at the activity, class, and/or program levels using a visual interface for establish the learning program and assessments, and to measure student performance on those outcomes through assessments.

Accordingly, what is needed is a learning management system that takes a novel and holistic approach to learning management by combining the content serving of an LMS with the ability to define and measure (assess) specific data points.

### SUMMARY OF THE INVENTION

The present invention is intended for use in the field of online learning and was created to design, deliver, measure, track, and manage educational courses and programs. The present invention has implications for the online educational system, which is rapidly growing in the online space. The present invention can be used to improve the quality and consistency of online course delivery and provide critical analytics to administrators. It is directly applicable to competency-based programs and traditional seat-time-based online courses alike. Similarly, the present invention can be used in the corporate space to implement large-scale training programs in an online format.

The present invention is an integrated suite of web applications configured and designed to allow a user of a computerized system operating such web applications to design, deliver, measure, and manage educational content. It provides for a number of necessary functionalities in this process, including source control service, content service, curriculum mapping, assessment/rubric generation, stylized content experience for learners and instructors (learning path), and data analytics for learners, instructors, and administrators. These functionalities are briefly summarized below.

The present invention acts as a source control server for educational content. The present invention uses Git Protocol software, which is a distributed revision control system. This provides for an institution's/company's educational content to be stored on the present invention, allowing for multiple users to edit the same content and permitting full version tracking capabilities.

The present invention provides users with a unique, visual curriculum mapper. Using this tool, users can create programs, courses within programs, and topics within those courses. Users can create and assign learning outcomes to each of those levels and connect them to assessments. The relationships between all of these items can then be manipulated visually.

The present invention also serves as a content server, serving educational content into a Learning Management System (LMS) using the universal Learning Tools Interoperability® (LTI®) standard. Learning Tools Interoperability also referred to as LTI® is a trademarked specification developed by IMS Global Learning Consortium. The principal concept of LTI® is to establish a standard way of integrating rich learning applications (often remotely hosted and provided through third-party services) with platforms like learning management systems, portals, learning object repositories, or other educational environments. In LTI® these learning applications are called Tools (delivered by Tool Providers) and the LMS, or platforms, are called Tool Consumers. The basic use case behind the development of the LTI® specification is to allow the seamless connection of web-based, externally hosted applications and content, or Tools (from simple communication applications like chat, to domain-specific learning environments for complex subjects like math or science) to platforms that present them to users. In other words, if you have an interactive assessment application or virtual chemistry lab, it can be securely connected to an educational platform in a standard way without having to develop and maintain custom integrations for each platform.

When serving education-related content, the present invention creates a stylized experience referred to as the “learning path”. The learning path is used to refer to the “user experience” which is the user's encounter and interaction with the entire learning process which is purposely crafted and orchestrated to enable the user to achieve the learning program outcomes. The learning experience is further specifically designed to provide end users (students and instructors) with an interface that follows the conventions of user experience best practices.

For example, specific actions are cued to the end user through specialized icons instead of text. Additionally, progress bars allow the end user to quickly determine their place in the course. The present invention does this through a combination of cascading style sheets (CSS) and JavaScript® code. The present invention also inserts assessment/rubric objects, as defined in the curriculum mapper, into the learning path. The assessments and rubrics (if applicable) appear in-line with the content.

The present invention also measures and presents data to users. First, learners and instructors can see information through the Student Progress Dashboard, which is served to the LMS through LTI®. As learners make their way through the content, they will interact with the assessments that appear in-line. Once they complete assessments, their work will be stored in a Learning Records Store (LRS) within the present invention. As instructors grade learners' assignments and rate them for efficiency, this is recorded in the LRS. Learners can then see their individual progress against learning outcomes, any applicable grades, and time spent on various tasks in the Student Progress Dashboard. When instructors view the Student Progress Dashboard, they can see these data points aggregated for all students or by individual student.

The present invention also allows administrators of courses and programs to log directly into the system to view large-scale analytics. From this area, users can view statistics such as overall learner performance against outcomes and content usage in a real-time or archived fashion. The analytics are drawn from the information stored in the LRS and the data gathered through JavaScript® code that is injected into the content pages that are produced by the present invention.

The present invention also provides for standard user management functionalities. Users are given accounts based on an email address and login using that address as their username. Users are given a user role by an administrator; this user role determines to which areas of the present invention the user will have access and any read/write capabilities.

The invention provides for:

Using the visual real-time curriculum mapper to connect assessments to rubrics to outcomes; these connections generate data for the dashboards;

the parsing of plain HTML content into a stylized responsive learning path that includes assessments, rubrics, an outcomes dashboard, real-time collaboration, student performance alerts, and other dynamic content to create the student experience;

a unique manner in which the assessments, rubrics, and specialized interactive activities are inserted as inline content by replacing special snippets (tokens) with enriched content;

interaction between the learning path and the student dashboard;

a centralized product management dashboard to create learning containers for content source control, publishing, serving (LTI® links), assessment creation, rubric creation, and outcomes curriculum mapping;

a data analytics reports interface; and

using an API to collect responses inline and externally report learner data, such as grades, course completion, usage, and outcomes progress.

The invention features a computerized system (and method) for establishing and providing an online competency-based learning program to remote users. The computerized system comprises one or more computer processors as well as a user defined learning program receiver, for receiving at least one user defined learning program. The system includes a user defined learning program outcome receiver, responsive to at least one user defined learning program, for receiving one or more user defined learning program outcomes desired from the at least one user defined learning program.

A user defined learning program course receiver is provided and is responsive to the received user defined one or more learning program outcomes, for receiving, for each one of the user defined one or more learning program outcomes, a plurality of user defined learning program courses, each of the plurality of user defined learning program courses configured to insure the remote users studying the online competency-based learning program meet the one or more learning program outcomes, and for associating at least one of the plurality of user defined learning program courses with at least one of the one or more user defined learning program outcomes.

The system also includes a user defined course outcome receiver, responsive to the received one or more user defined learning program courses, for receiving, for each one of the user defined learning program courses, one or more user defined course outcomes, and for associating at least one user defined course outcome with each of the one or more user defined learning program courses. A course level module receiver is responsive to the received one or more user defined course outcomes, for receiving, for each of the one or more user defined course outcomes, one or more course level modules, and for associating at least one user defined course level module with each of the one or more user defined course outcomes.

A course level module outcome receiver is provided, which is responsive to the received at least one user defined course level module, for receiving, for each of the one or more user defined course level modules, one or more course level module outcomes, and for associating at least one user defined course level module outcome with each of the one or more user defined course level modules. Also provided as part of the computerized system is at least one computer accessible online learning program content database.

The computerized system responsive to the received one or more user defined learning program outcomes, the received one or more user defined courses, the received one or more user defined course outcomes, the received one or more course level modules and the one or more user defined course level module outcomes, for storing the received one or more user defined learning program outcomes, the received one or more user defined courses, the received one or more user defined course outcomes and the one or more user defined course level module outcomes in the at least one computer accessible online learning program database.

A learning program content authoring device is provided and is responsive to user input, for receiving user provided learning program content, learning program course content, course outcome content, course level module content and course level module outcome content, for storing the user provided content in the at least one computer accessible online learning program database, and for associating the user provided learning program content, the user provided learning program course content, the user provided course outcome content, the user provided course level module content and the user provided course level module outcome content with a corresponding the one or more user defined learning program outcomes, the one or more user defined learning program courses, the one or more user defined course outcomes, the one or more course level modules and the one or more user defined course level module outcomes previously stored in the computer accessible online learning program database.

The computerized system is further responsive to user input, for receiving at least one of user defined learning program outcome testing information, user defined course testing information, user defined course outcome testing information, user defined course level module testing information, and one or more user defined course level module outcome testing information, and for associating the testing information with a corresponding one of the one or more user defined learning program outcomes, one or more user defined courses, one or more user defined course outcomes, and the one or more user defined course level module outcomes, and for storing the testing information in the at least one computer accessible database.

The computerized system also includes a computer accessible remote user online competency-based learning program completion status database, the remote user online competency-based learning program completion status database configured for storing learning program completion information related to each remote user's status of completion of each remote user's one or more user defined learning program outcomes, one or more user defined courses, one or more user defined course outcomes, one or more course level modules and one or more user defined course level module outcomes.

A user interface is provided which is coupled to the at least one computer accessible database and the computer accessible remote user online competency-based learning program completion status database, and responsive to a request from one or more remote users to access a learning program, for accessing the computer accessible remote user online competency-based learning program completion status database and the at least one computer accessible database, and for providing a requesting remote user with one of the user provided learning program content, online learning program course content, user provided course level module content, online learning course outcome content and online learning course level module outcome content and for providing at least one of associated user defined learning program outcome testing information, user defined course testing information, user defined course level module testing information, user defined course outcome testing information, and user defined course level module outcome testing information from the at least one computer accessible database based upon learning program completion information about the remote user stored in the computer accessible remote user online competency-based learning program completion status database.

The computerized system may be configured such that the at least one of the user defined learning program outcome testing information, the user defined course testing information, user defined course level module testing information, the user defined course outcome testing information, and the user defined course level module outcome testing information includes testing information selected from the group of testing information consisting of objective assessment testing information, non-objective assessment testing information, and rubric based testing information.

The at least one computer accessible database may include a learning program content source control database, and wherein the learning program content authoring means is configured for storing the user provided learning program content, the user provided course content, the user provided course outcome content, the user provided course level module content and the user provided course level module outcome content associated with the corresponding the one or more user defined learning program outcomes, the one or more user defined courses, the one or more user defined course outcomes, the one or more course level modules and the one or more user defined course level module outcomes in the learning program content source control database.

The computerized system user interface means may include a third party Learning Management System and may also include at least one computerized system instruction storage medium, for storing non-transitory computer system operating instructions.

The computerized system may be responsive to non-transitory computer system operating instructions stored on a storage medium remote from the computerized system, and the non-transitory computer system operating instruction storage medium may be located remotely in the cloud and coupled to the computerized system by means of the internet.

Specifics of the features and functionalities of the present invention will become apparent upon reading the following description of the preferred embodiment, when taken in conjunction with the drawings and the claims.

### BRIEF DESCRIPTION OF THE DRAWINGS

These and other features and advantages of the present invention will be better understood by reading the following detailed description, taken together with the drawings wherein:

FIG. 1 is a schematic block diagram of a computerized system with and on which may be implemented the present invention;

FIG. 2 is a flow chart illustrating the method of providing curriculum mapping in accordance with one feature of the present invention;

FIG. 3 is a screen shot of one implementation of a user display of information entered into the curriculum mapper for one course, in accordance with a feature of the present invention;

FIG. 4 is a screen shot of one implementation of the curriculum mapper according to one feature of the present invention;

FIG. 5 is a screen shot of one implementation of the manage assessments screen of the assessment generator in accordance with another feature of the present invention;

FIGS. 6A and 6B are screen shots of two examples of the add assessment screen of the assessment generator in accordance with one feature of the present invention;

FIG. 7 is a screen shot of one implementation of the manage rubrics screen of the rubric builder feature of the present invention;

FIG. 8 is a screen shot of one implementation of the add rubric screen of the rubric builder feature of the present invention;

FIG. 9 is a schematic diagram illustrating how the present invention implements source control to various authored elements;

FIG. 10 is a screen shot of one implementation of a viewed details Project screen in accordance with yet another feature of the present invention;

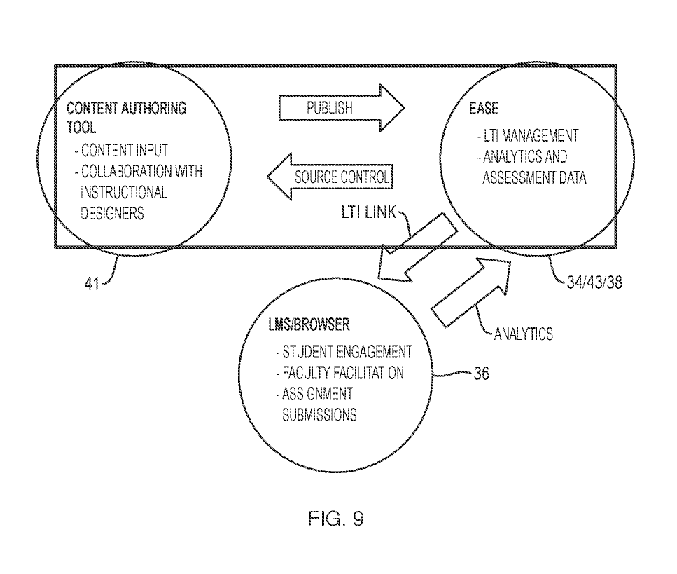

FIG. 11 is a screen shot of one implementation of an add publishing destination feature of the present invention;

FIGS. 12A and 12B are screen shots of one implementation of the add and manage LTI® link features in accordance with one feature of the present invention;

FIG. 13 is a screen shot of one implementation of an assessment view of a student progress dashboard in accordance with one feature of the present invention;

FIG. 14 is a screen shot of one implementation of a messaging view of a student progress dashboard in accordance with one feature of the present invention;

FIG. 15 is a screen shot of one implementation of an instructor progress dashboard in accordance with yet another feature of the present invention;

FIG. 16 is a screen shot of a rubric view of the instructor progress dashboard of the present invention;

FIG. 17 is a screen shot of an exemplary analytics dashboard in accordance with one feature of the present invention; and

FIG. 18 is a schematic block diagram of the various data paths and data provided by the computerized system and method according to the present invention.

### DETAILED DESCRIPTION OF THE PREFERRED EMBODIMENT(S)

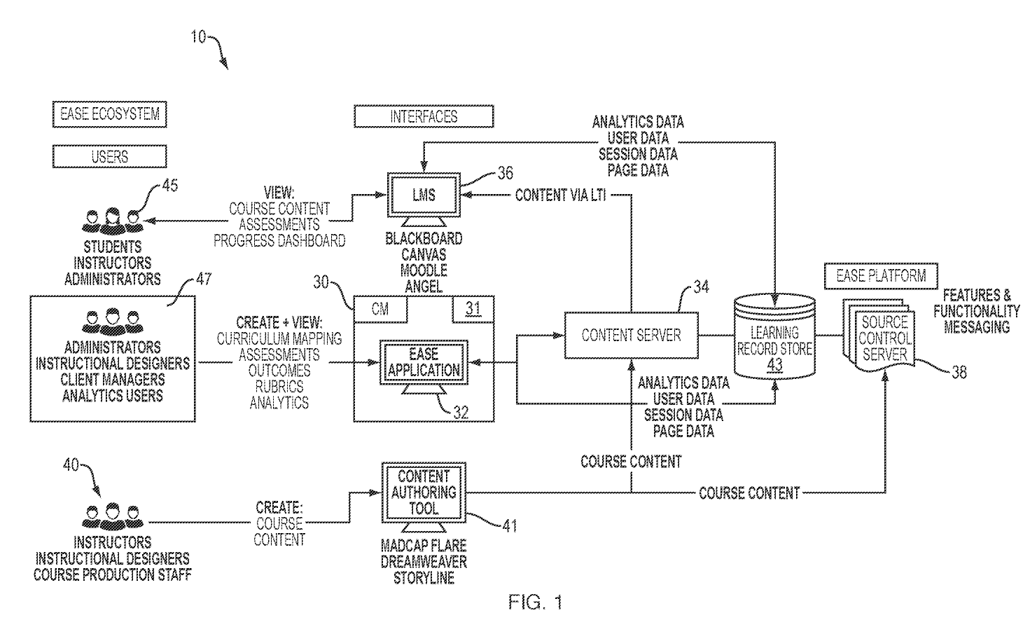

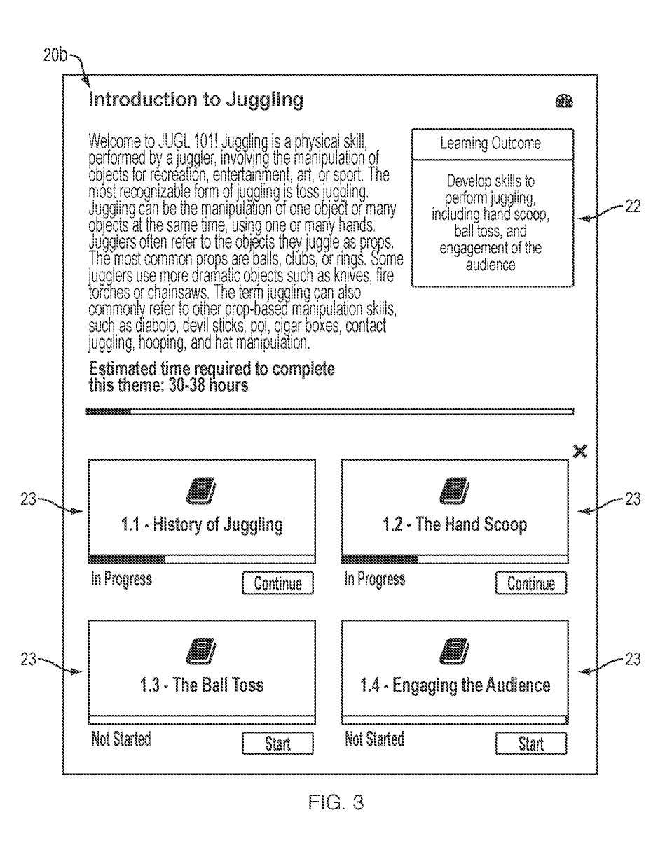

The detailed description of the preferred embodiment of the present invention will use the example of a fictional college “Constantly Classic Circus School” (CCCS) to demonstrate its features. CCCS wishes to offer an on-line course of study (“the program”) leading to a Bachelor's of Arts degree in Circus Performance (BACP) for those who wish to gain the requisite knowledge, skills, and dispositions to perform in the circus. In this program of study, there will be a course about juggling: Juggling 101 (JUGL 101-See FIG. 3). In the following detailed description, this fictional college's programs and course offerings will be used to explain the curriculum mapper, assessment generation and rubric building, source control service, content service, the learning path, student and instructor dashboards, and data analytics dashboard for the present invention. FIG. 1 shows a sample system environment 10 for implementation of the present invention, and where each of these pieces is available/resident (although the location of any “piece” described in connection with the following description as well as the functionality of any and all “pieces” may be moved and/or physically or logically located anywhere within or external to the system 10).

The present invention is implemented as a computerized system including a computer processor and associated memory 32 and well as one or more data storage devices 34, 38, 43 and computer program storage medium 31. The computer processor 32 operates pre-programmed, non-transitory instructions provided on the computer program storage medium 31, wherein the instructions are designed to cause the computer processor 32 to provide the disclosed features and cause the computerized system 10 to operate according to the described method. The pre-programmed, non-transitory instructions provided to the computer processor 32 may be provided from the “cloud”. The cloud is a network of servers, and each server has a different function. Some servers use computing power to run applications or “deliver a service.” In the present case the “service” may be the functionality described herein as ascribed to the processor 32 and non-transitory software on the storage medium 31.

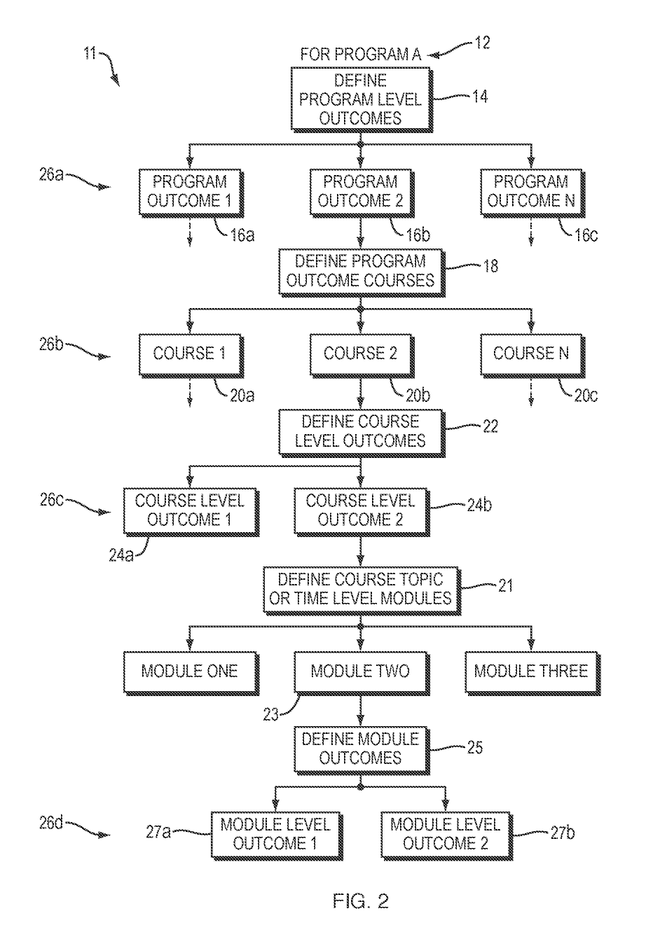

The description of one portion of the method of the present invention is shown schematically in the flow chart 11 of FIG. 2 and begins as college CCCS is beginning to plan their BACP program 12. To conceptualize this program, CCCS may employ a methodology known as backwards design. The backwards design methodology is centered on starting with the desired end product or end result first, and subsequently working backwards from there to ensure every aspect of the desired end product is covered. For example, CCCS would first define learning outcomes 16 for the students at the program level, step 14; in other words, students need to have met these outcomes 16 by the time they finish all of their course work in the program 12 and are ready to graduate. Part of defining the learning outcomes 16 is also defining an associated requisite competency based testing (assessment) required to insure that the student has appropriately learned or met the associated defined learning program outcome 16. Because these outcomes 16 are designed to be met over the duration of a program, they need to be broken down, on a first level at step 18, into smaller, more specific outcomes defined as courses 20 (See FIGS. 2 and 3).

To meet these course 20 objectives, CCCS also needs to define course outcomes 22 for the courses 20. A module (i.e. topic) 23 is a subdivision of a course 20, either by time or topic and associated with one or more course level outcome(s) 24. For example, if a course 20 is 10 weeks in duration, it could have 10 modules 23 (one for each week). Alternatively, that same course 20 could be arranged by topic. If there were four different major topics, there would be four different modules 23, FIG. 3. Module-level outcomes 27 will be smaller, more specific and more detailed “pieces” of the course outcomes 24. The student therefore will work to meet module-level outcomes 27 until they have completed all modules 23. Similarly, as they meet course outcomes 24 and complete courses 20, they will be working towards completion of program outcomes 16. This hierarchical methodology is performed and repeated for each program outcome 16 for the program 12. FIG. 2 shows the logical connection and arrangement of the hierarchical structure of the curriculum mapper methodology of the present invention, and although the logical arrangement will always be present, not all physical “levels” may be present. Along with each defined module level outcome 27 (or other relevant outcomes) will be an associated and predefined competency based testing which the student will have to complete before he or she can have that module of the course considered completed and move on to another module.

In the context of the present invention, this process (described in connection with FIG. 2 and shown for one course 20b in connection with FIG. 3) is known as curriculum mapping. The present invention allows for this process through its unique, visual interface referred to herein as the curriculum mapper. The curriculum mapper 30, FIG. 1, is implemented in the preferred embodiment as non-transient computer software, either resident on the computer processor 32, resident in a locally associated storage medium or stored in the “cloud” and run by the computer processor 32, designed to operate on a computer processor 32 and once operating on the computer processor 32, the curriculum mapper 30 software is configured for causing the processor 32 to provide the visual interface described herein and referred to as the curriculum mapper 30. This curriculum mapper visual interface as shown in FIG. 3 allows editing of the program, course and module levels in one interface.

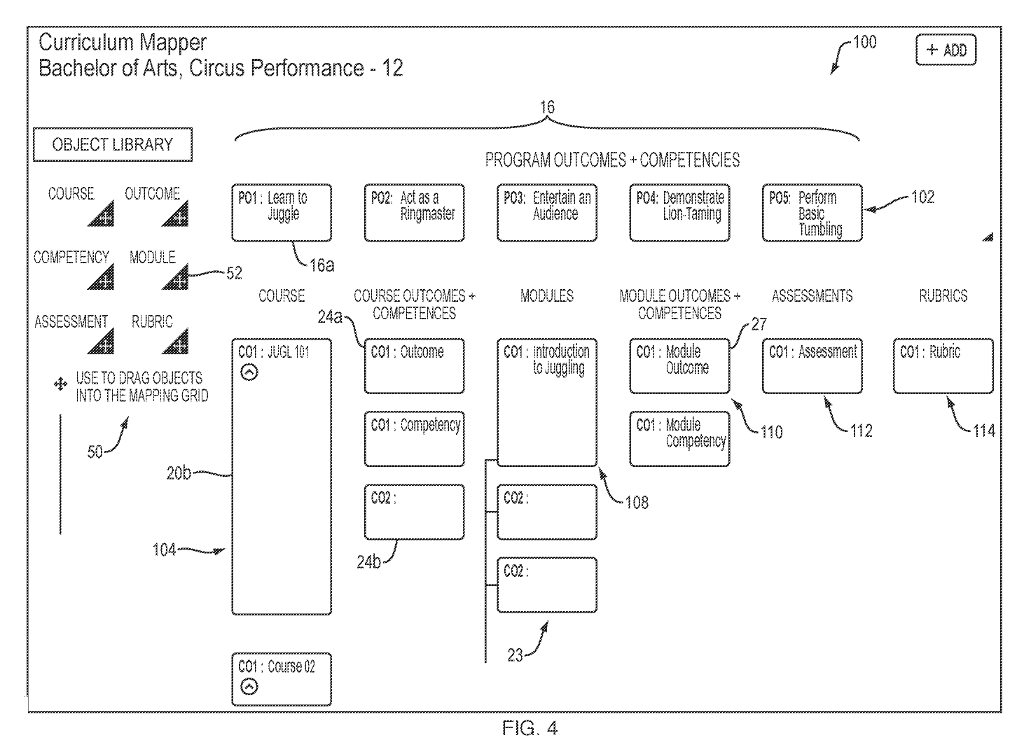

For CCCS, the curriculum mapper means that they can plan their BACP program 12, working from their program-level outcomes 16, to the course level 20, and finally at the individual modules 23 for the courses 20. The drag-and-drop functionality from the Object Library 50, FIG. 3, allows users to easily add the various components of their program. The Object Library 50, shown on the left portion of the visual interface shown in FIG. 4, allows users to add courses, outcomes, competencies, modules, assessments, or rubrics to the program for the purpose of mapping out the program.

Starting at the program level on the present invention's processor operating the curriculum mapper software 30, educational professionals at CCCS would add one or more program level outcomes 16. After being added, each program outcome 16 would be defined. For example, a graduate of a program about circus performance would need to be able to “integrate technical and artistic skills into a sustained, choreographed performance of a circus” (as detailed in the program outcomes 16). This could include learn to juggle, act as a ring master, entertain an audience, lion taming, perform basic tumbling and so on.

So, CCCS personnel may begin by defining the first program outcome 16a, which is “Learning to Juggle”. This outcome 16a states the need for graduates to be technically proficient in juggling to meet this program outcome. By editing the program outcome item 16a, the user can add this text to finalize their first outcome 16a. This process (adding an outcome item and creating the text) would be repeated for the number of program-level outcomes 16 that CCCS feels is appropriate for students in the BACP program.

After entering the program outcomes 16, CCCS determines what courses would be appropriate in this program to support students in meeting those outcomes, step 18 FIG. 2. Using the Object Library 50 FIG. 4 function of the visual curriculum mapper 30, CCCS can add a course object 20 (for example Juggling 101) to the curriculum map for this program 12. Once added, the user can set a short name and description for the course 20. The process of adding courses 20 is repeated until the desired number of courses 20 have been created for the outcome 16.

Once courses 20 have been defined and added, CCCS can establish course-level outcomes 24. The program-level outcomes 16 are very broad and mastery of them must be demonstrated over time in numerous areas. Take, for example, the first program outcome 16a: “Learn to Juggle.” To build this skill towards this program outcome 16a, CCCS decides that it must have a course about juggling, course No. 2, 20b, for example, titled JUGL 101. The skills learned about juggling in this course will help students meet a portion of the first program outcome 16a “Learn to Juggle”. To this end, CCCS decides, step 22, on at least one course outcome for JUGL 101 namely outcome 24a. In the curriculum mapper interface of the present invention shown at 100, FIG. 3, a representation of the visual presentation provided by this interface is shown, and CCCS adds course outcome 24a to the curriculum mapper. Course outcomes are added by dragging over one or more “outcome” items from the Object Library 50 into or as part of course CO1 JUGL 101 20b. Each course outcome 24 can be given a title and description. The first course outcome 24a might be titled “Demonstrate motor coordination, concentration, and spatial orientation by juggling multiple items for sustained periods.” This outcome speaks to the technical aspects of juggling, specifically requiring the student to be able to juggle for an extended period of time. A second course outcome 24b might be titled “Demonstrate stage presence by connecting with audience, verbally or non-verbally.” As opposed to the first outcome, this speaks to the performance aspect of juggling.

Both are valid goals for a juggler, and both are conceptually “child” outcomes of the parent program outcome 16a “Learn to Juggle”. To denote this relationship, the curriculum mapper allows CCCS to create associations between these two course outcomes 24a and 24b and the first course 20b and the program outcome 16b. When making this association, CCCS must decide how much of the first program outcome each course outcome is worth for purposes of assessment or testing.

The first and more technical outcome might be deemed important by those creating the program and be assigned a weight of 35%. In other words, 100% completion of JUGL 101's first course level outcome 24a would count as 35% of the first program outcome 16b. The second course level outcome might be less important and be assigned a value of 15%. This would mean that 100% completion of JUGL 101's second course level outcome 24b would count as 15% of the first program outcome 16b. By default, the present invention automatically distributes each child outcome associated to a parent evenly; for example, if 5 children outcomes 24 were associated to a parent outcome 16, each would be 20% by default. If one of those were removed, the values would reset to 25%.

With the course-level outcomes 24 set, CCCS can move on to deciding how to organize the modules of the course. As discussed previously, modules can be organized by time or topic. For JUGL 101, CCCS decides to organize their modules 23 by topic. CCCS can add these modules to the curriculum map 100, using the drag-and-drop functionality of the Object Library 50, FIG. 3. To do this, CCCS would click and hold the “module” item 52 in the Object Library 50. Then, they would drag it into the module area for the JUGL 101 course they are building. As with the courses 20, the modules 23 created can be given a title and description. These individual modules 23 are designed to help impart the knowledge, skills, and abilities to meet the course outcomes 24. As with the program-to-course relationship, CCCS has the option to designate module outcomes 27 in each module. Each module outcome 27 can be given a title and description. Similarly, each module outcome 27 can be associated with a course outcome OR program outcome (in rare cases, this is warranted). The association between a program outcome and module outcome 27 is illustrated with reference to FIG. 3.

Given the number of relationships that will be created for CCCS during the conceptual mapping of their BACP program, users will need the ability to limit and control the amount of information they are seeing as they are using the curriculum mapper to map out the program. The present invention allows users to do this in a number of ways. The top level of outcomes 102, FIG. 4 (program-level outcomes 16 in this case), is always visible, displayed horizontally across the top of the curriculum mapper. Underneath this level of outcomes are the other major groupings of outcomes/objectives and content areas. They are displayed in order of hierarchy, from the left to right. In this example, those are course 104, course outcome 106, module 108, module outcome 110, assessment 112, and rubrics 114; the placement of assessments and rubrics will be discussed below.

As users add items of all types, they are able to collapse the content areas (courses and modules) to hide items within them. Users may elect also to see all mappings associated with one program outcome item (see FIG. 4). The association can be direct or through a child outcome or content area.

Consider the present example; if the user selected to see the mappings with the first program outcome 16b, everything would be hidden except for the selected JUGL 101 course, the first and second course level outcomes 24a and 24b associated with that course, the module 23 associated with that outcome and any associated module outcome 27 within which the assessment is given, the three-ball juggling assessment (discussed below), and the rubric for that assessment (also discussed below), all of which would be the only items shown.

In the present example, CCCS wishes to use assessments to measure progress against the first and second course outcomes. An assessment is a way of evaluating the state of a student's learning on a particular topic (or topics). This is seen in many different ways in education; a multiple-choice test is an assessment, as is a term paper. Users of the present invention are able to create these assessments through the assessment generator. This function of the present invention allows user to define the type of assessment, the content of an assessment, and the value of an assessment. For the present example, CCCS determines that the three-ball juggling assessment will be performance-based and not objective. An objective assessment is an assessment in which the right and wrong answers are clear cut. A good example of this is a multiple-choice test. Each question has a clear answer, either A, B, C, or D. A performance-based assessment is one that is less cut-and-dry and requires guidelines for grading. While CCCS does not know the specifics yet, they know that they want a final overall “assessment” in the course that will test a student's comprehensive course experience (i.e., knowledge). In other words, the assessment will test students on their technical ability to juggle (the first course outcome 24a) and their performance ability (the second course outcome 24b). CCCS will need to access the assessment generator and rubric builder to build the specifics of this assignment.

From the home screen of the present invention CCCS is able to access the assessment generator. From this portion of the present invention, CCCS is able to generate a variety of assessments, either objective or performance-based. If the assessment is performance-based, it will need a rubric. A rubric is a scoring guide that helps teachers evaluate student performance based on a range of criteria. For example, if students are told to write a paper on Napoleon, the assessment of the paper is not black and white as an objective assessment would be. The rubric becomes a framework within which the student will approach the paper, and will outline performance categories and assessment guidelines for the students. For the paper about Napoleon, for example, the performance categories might be historical information about Napoleon, use of historical sources about Napoleon, and writing mechanics.

A rubric lists the criteria, or characteristics, that student work should exhibit and describes specific quality levels for those criteria. A rubric is typically set out as a matrix of criteria and their descriptors. The left side of a rubric matrix lists the criteria for the expected product or performance. Across the top of the rubric matrix is the rating scale that provides a set of values for rating the quality of performance for each criterion. Descriptors under the rating scale provide examples or concrete indicators for each level of performance.

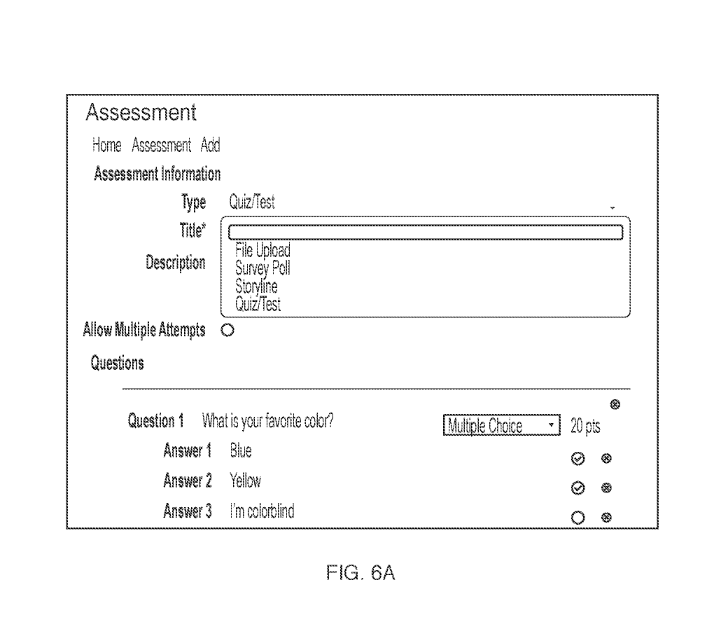

The assessment generator, FIG. 6A, of the present invention provides a means for creating both objective and performance-based assessments. First, upon creation, an assessment must be given a title, a description (which will include instructions and other information to be displayed to the end user (student or instructor)), and point value. To then determine if the assessment is objective or performance-based, the assessment must be given a type. There are four types of assessments: test/quiz, survey, custom, or file upload. For objective assessments, the present invention can create a Test/Quiz or Survey assessment type. See for example FIGS. 6A and 6B.

In the Test/Quiz assessment type, users can create multiple choice questions, true/false questions, and short answer (text-entry) questions. Each question can be given text, a point value, and an indicator of the correct answer. To align with the curriculum mapper, each objective assessment can be mapped as a whole to any level of outcome (program, course, module, etc.) or it can be mapped question by question to any level of outcome.

The Survey assessment type is the same as the Test/Quiz type, but is used for ungraded and less objective activities such as gathering general feedback from students about a particular course or module. As such, it does not need a point value or outcome mapping. The custom type could be either objective or performance-based depending on its content. This assessment type is designed to be interactive and provide the ability for users of the present invention who create the assessment to incorporate custom/specialized technology. When creating one of these types, users will need to indicate if it requires a rubric.

For most performance-based assessments, the “file upload” assessment type will be used. See FIG. 6B. A video presentation, a PowerPoint® slideshow, and a research paper are all examples of files that can be uploaded for this type of assessment. The user would select this type and then enter a title, description, and point value for the assessment. The description should be detailed enough to include instructions about the creation of the file to be uploaded. The specifics of how the file will be graded by rubric and creation of the rubric will be outlined in the description of the rubric builder.

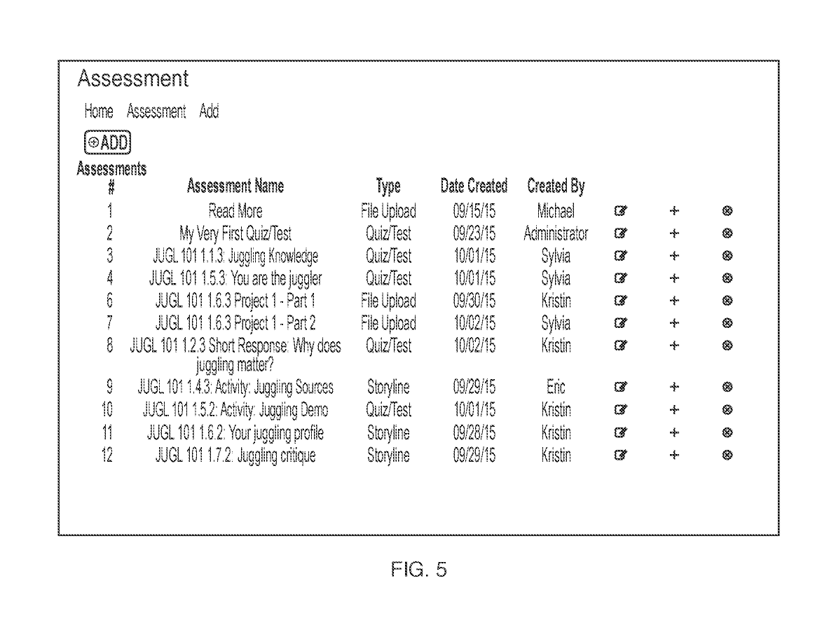

Returning to the CCCS example, it is determined that a final project for JUGL 101 must be created. Because this assessment needs to test students on their technical ability to juggle (the first course outcome) and their performance (the second course outcome), it is a perfect candidate for a performance-based assessment. CCCS accesses the assessment generator interface in the present invention (see FIG. 5). Here, they indicate that they wish to add an assessment. FIGS. 6A and 6B show representative screens for adding an assessment. First they select file upload (FIG. 6B for example). Then, they establish an assessment title, description, type of file to upload, and point value. A representative entry might be:

Title: Three Ball Juggling

Description: For this assignment, you will juggle 3 balls. To demonstrate proficiency, you must:
Keep your hands about waist level on a consistent basis, starting from the outside and moving in a scooping motion toward the midline
Perform multiple consecutive ball tosses
Perform multiple consecutive right-left-right, and left-right-left throws
Consistently maintain engagement with the audience, either verbally or non-verbally.

Record this performance on video and upload the completed performance.

Point Value: 100

There is also the option for selecting a rubric to be associated with this assessment. Once these fields are set, the assessment can be saved. This will return the user to the manage assessment screen (FIG. 5). On this screen, CCCS is able to generate a token for their assessment based on its project and publishing destination (both are explained later). A token is a specific string of characters that is recognized by the present invention as being associated with a predefined object. This token system can be used for assessments or stylized user interactions, such as embedded video or buttons for launching external hyperlinks. In this case, it is utilized for indicating where in the content their assessment should go. As the present invention serves the content from the source control to the end user, it will replace this token with the assessment that it is associated with. Content serving is explained in detail below.

With this performance-based assessment defined, CCCS now needs a way for instructors to know how to grade the videos that are submitted. Similarly, students might want a visual scorecard to know how, exactly, they can demonstrate proficiency in each of the areas listed. For the students, a rubric clarifies expectations. For instructors, it ensures consistent grading.

The rubric builder provides users of the present invention a mechanism to create these rubrics. A rubric is a document that conveys expectations on how a student can demonstrate success on a performance-based assessment; it also serves as a guide for an instructor when grading. Rubrics have become popular with teachers as a means of communicating expectations for an assignment, providing focused feedback on works in progress, and grading final products. Although educators tend to define the word “rubric” in slightly different ways, one commonly accepted definition is a document that articulates the expectations for an assignment by listing the criteria, or “what counts”, and describing levels of quality from excellent or proficient to poor or not evident.

Rubrics are often used to grade student work but they can serve another, more important, role as well: Rubrics can teach as well as evaluate. When used as part of a formative, student-centered approach to assessment, rubrics have the potential to help students develop understanding and skill, as well as make dependable judgments about the quality of their own work. Students should be able to use rubrics in many of the same ways that teachers use them, namely, to clarify the standards for a quality performance and to guide ongoing feedback about progress toward those standards.

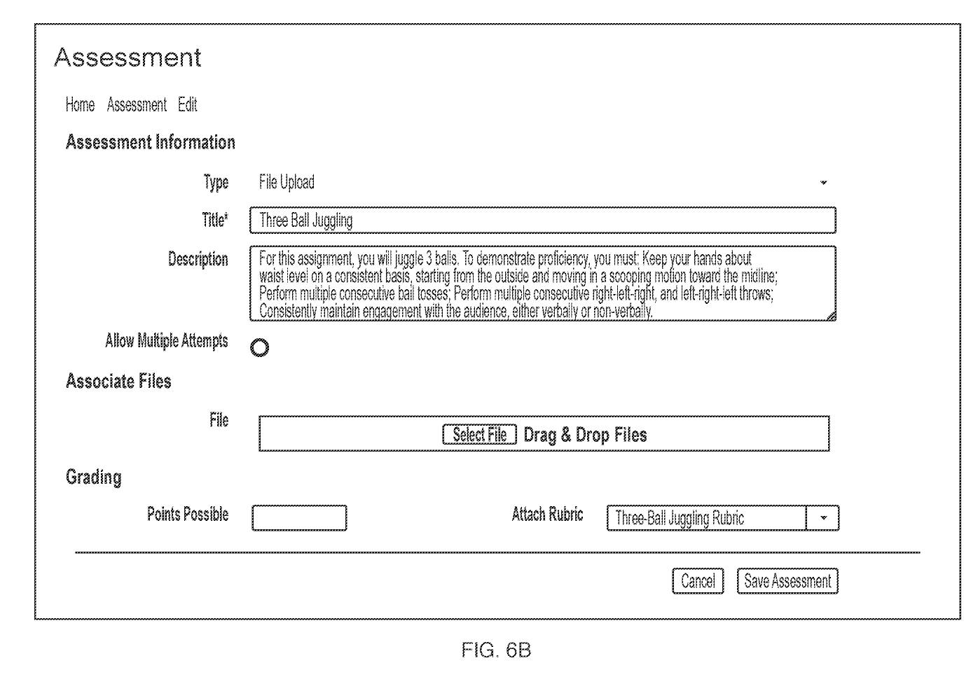

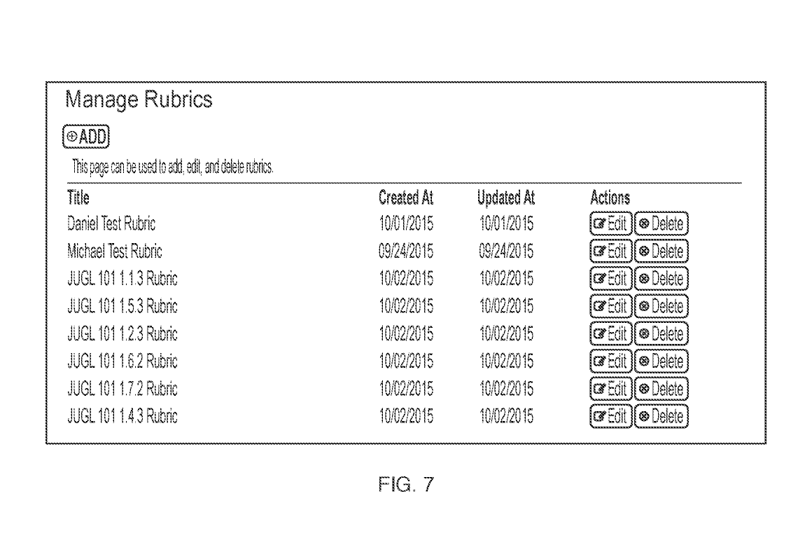

For example, if a performance-based assessment ball toss FIG. 8, is desired, a rubric may be necessary. When it is decided that a rubric is needed for an assessment, users access the rubric builder, see FIG. 7. To create a new rubric, users add the needed number of demonstration criteria; these are the general requirements that students need to meet for the assignment. On the rubric matrix, they are represented by rows (see FIG. 8). The columns on the rubric matrix represent the level of performance. In FIG. 8, these levels are proficient, needs improvement, and not evident. The performance levels align with the rows of demonstration criteria. The result is that users can define specifics for each performance level of the demonstration criteria.

To illustrate this, consider the current example of JUGL 101. With the Three Ball Juggling assessment created, there are clear demonstration criteria: hand scooping motion, ball toss, r-l-r and l-r-l throw and catch, and audience engagement. The assignment specifically states how the student should perform each criterion. To create the rubric for this assessment, CCCS first accesses the rubric builder tool, FIG. 7, in the present invention. They create a new rubric and title it “Three Ball Juggling Assessment Rubric.” Then, using the rubric interface, they add the demonstration criteria required for this assignment, namely, “hand scoop”; “ball toss”; and “audience engagement”. As they are added (or after all four demonstration criteria are added), the titles of the demonstration criteria can be entered.

Once the demonstration criteria have been entered and titled, the specific performance levels for every demonstration criteria can be entered. In this case, there are four demonstration criteria (Hand Scoop, Ball Toss, Throw and Catch, and Audience Engagement) and three different performance levels: Not Evident, Needs Improvement, and Proficient. Because each demonstration criteria has three performance levels, there are a total of 12 text boxes that need to be defined (see FIG. 8).

For example, consider the demonstration criterion Hand Scoop. This criterion is regarding the student's ability to, according to the assessment instructions, “Keep your hands about waist level on a consistent basis, starting from the outside and moving in a scooping motion toward the midline.” Because this is defined as the proficient performance, this is the text that CCCS would enter in the text box shown on FIG. 8 for the Proficient performance level in the Hand Scoop demonstration criterion.

Next is the performance level Needs Improvement; this level denotes a partial demonstration of the criterion with some improvement needed to be called proficient. For the Hand Scoop criterion, a good definition of Needs Improvement would be “Hands make scooping motion on a consistent basis but sometimes come up to catch the ball.” Finally, for Not Evident, CCCS would decide on a description that denoted very little to zero demonstration of proficiency of the Hand Scoop. It could be something such as: “Does not perform hand scoop, or hands move above the waist.” With all of the performance levels for Hand Scoop defined, CCCS would repeat and enter the performance description for the rest of the demonstration criteria into their corresponding text boxes (see FIG. 8 for an example of the performance descriptions).

With the demonstration criteria and their corresponding performance levels defined, CCCS can use the rubric builder of present invention to assign value to each demonstration criterion and performance level. There are two types of value that can be assigned: the first denoting weighting in terms of outcomes and the second in terms of grade. To determine value for outcomes, the demonstration criteria each must be mapped to an outcome.

In this example, there are two course outcomes for JUGL 101: the first is related to the technical skill of juggling: “Demonstrate motor coordination, concentration, and spatial orientation by juggling multiple items for sustained periods.” The second is related to the performance aspect of juggling: “Demonstrate stage presence by connecting with audience, verbally or non-verbally.” To map this rubric's demonstration criteria to the outcomes, CCCS must decide which outcome each demonstration criterion aligns with. Looking at the four demonstration criteria, the first three demonstration criteria (Hand Scoop, Ball Toss, Throw and Catch) all relate to the technical skill of juggling, which is the first course outcome. The last demonstration criterion, Audience Engagement, clearly relates to the second course outcome. These mappings are important because as students complete this assignment, they are showing quantifiable progress towards outcomes; in short, outcomes-mapping shows true student learning.

To use the present invention to make these mappings, CCCS will utilize the “Add Mapping” function of each demonstration criterion to make this connection, FIG. 8. For the first demonstration criterion, Hand Scoop, CCCS would click “Add Mapping”. This criterion aligns with the first outcome, so that outcome would be chosen. Finally, a value would be assigned. This value denotes the maximum percentage of the outcome that full demonstration of the criterion would give. If it is determined that this Hand Scoop is one of four major chances to demonstrate proficiency in the first course outcome, CCCS might assign a 25% value. This would mean that if a student was determined to have met the Hand Scoop demonstration criterion, that student would have met 25% of the first course outcome.

The possibility also exists, however, that a student will not demonstrate proficiency. The 25%, then, would not be fully gained. Performance levels (proficient, needs improvement, and not evident) are critical in defining how this value is scaled. When creating the rubric, each performance level can be assigned a value. In this example, proficient is 100%, needs improvement is 70%, and not evident is 0%. If a student was determined to meet the needs improvement level, the outcomes value given to the student would be 70% of 25%, or 17.5%. Of course, if a student was determined to meet the not evident level, there would be no value assigned. This assignment of value becomes important because it allows students, instructors, and administrators to track learning progress through data analytics (to be discussed below).

The other value to be determined in the creation of a rubric is the grade value. Unlike the outcome mapping, this value is used to assign a traditional number grade to the assignment. Each demonstration criterion can be assigned a point value; this assigned value represents the maximum number of points that a student can be awarded for the corresponding criterion. This is done through the Points field in present invention's Rubric Builder (see FIG. 8). The sum of these point values is the overall grade for the assignment. If CCCS determined that the grade for this assignment would be out of 100 points, they would have to distribute those 100 points amongst the 4 criteria. Each criterion could be given a value of 25 points each or, if the first three criteria (Hand Scoop, Ball Toss, Throw and Catch) were deemed to be more important to the assessment than the last criteria (Audience Engagement), each could be given a different value to denote this weighting, such as 30/30/30/10. When grading the assessment, instructors would have the ability to assign any value of points from 0-30 for the first three criteria and any points 0-10 for the last.

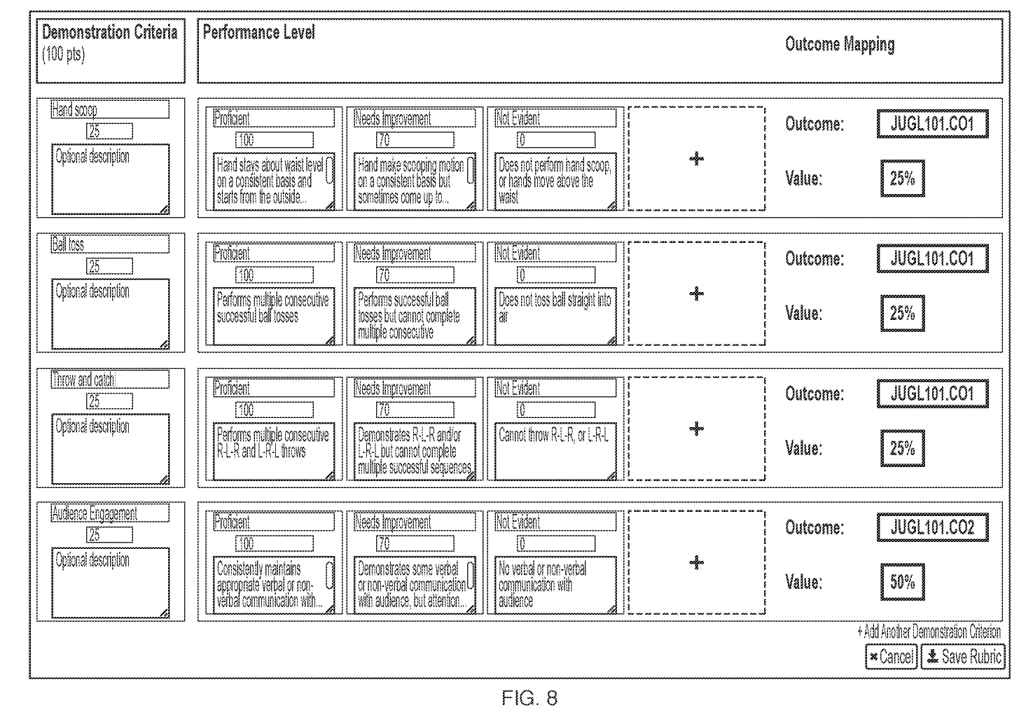

Thus far, the description has centered around building the basic educational elements of the BACP for the CCCS. The present invention, however, is also used to store course content (content server 34, FIG. 1) and serve it to Learning Management Systems 36. For storing course content, the present invention acts as a Source Control Server 38. This means that CCCS will be able to store their content on it, and it will allow for editing by multiple users 40 while providing comprehensive tracking of version history. The source control in the present invention utilizes Git protocol for its functionality. Git is a distributed revision control system that provides a complete history and full versioning for file systems it is used to source. See FIG. 9 for a conceptual diagram about source control in this system.

To do this, CCCS would log in to the present invention and “create a new project”. In the present system, a “project” is analogous to a course. Thus, for every course CCCS wants to deliver online using the present invention, it would need a project. On the new project creation screen, the user would select a name. In this case, it would be JUGL 101. After creation of the project, the relevant source control information is displayed: the URL for the repository, a username, and a password. This information is utilized by users to store, save, and track content for their online courses.

With the creation of this repository, CCCS can now work to establish the content for JUGL 101. Because of this centralized location, multiple stakeholders from CCCS can contribute to the course content in an asynchronous fashion. For example, a subject matter expert could add content to JUGL 101, while an instructional designer could vet the content for sound pedagogy and ensure all outcomes are met. After this is done, an administrator or full-time faculty member could review the content for a general approval. Source control provides for all of this to happen in one location, which is a more efficient approach than passing around documents or merging different versions.

Once the involved parties have collaborated on developing the content and have finalized the course, it is ready to be presented to students and instructors in the online environment. To do this, two main features of the present invention are utilized: publishing destinations and LTI® links (utilizing the universal “Learning Tools Interoperability”® standard). Both of these features are described in detail below. When considering this functionality, it is important to keep in mind the overall system environment (FIG. 1).

Publishing destinations provide the connection between the content in a project's source control file on the source control server 38 and the eventual LTI® link used to serve the content. This connection is established using File Transfer Protocol (FTP). Each publishing destination is assigned its own FTP username and password by the present invention; this information is used to access the relevant portion of the source control file stored on the source control server 38. For example, CCCS might have 12 different weeks within their JUGL 101 course. In their content authoring tool, while creating their content, they create 12 different sections within the file. Each of one these sections represents one week's worth of content. When this file is saved to the source control server 38, the present invention needs to know that these 12 different sections exist and how to access them. Publishing destinations provide this ability.

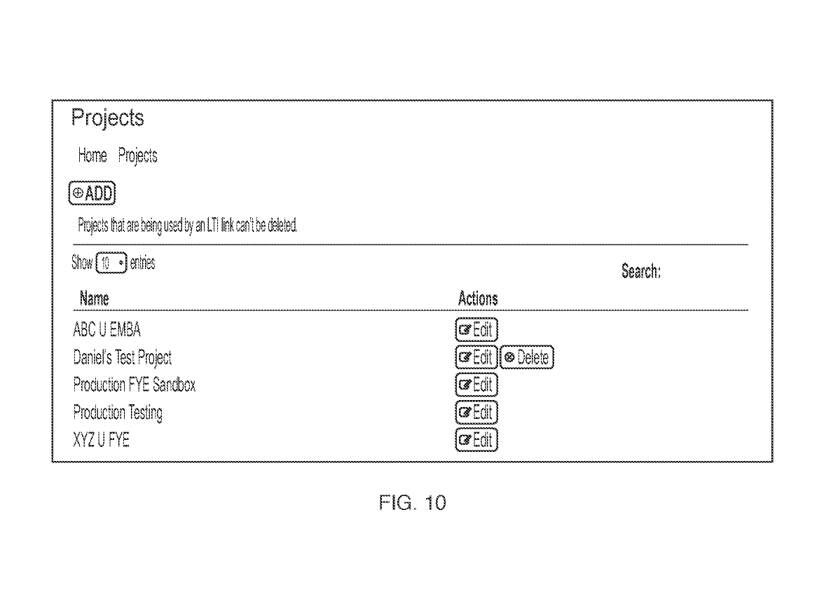

At the Project View Details screen (see FIG. 11) of their JUGL 101 project in the present invention, CCCS would use the “add publishing destination” function. The system would then prompt them for a name, a publishing destination type (described in the following paragraph), and an initial file. They would enter “Week 1” for the publishing destination name, select the appropriate publishing destination type as described below, and then select the initial file for the publishing destination (the default or initial HTML page for this section of the file). A CCCS user would then click “Save” to create the publishing destination and then repeat for Weeks 2-12. After creating each publishing destination, the CCCS user is returned to the View Details screen of the JUGL 101 project, FIG. 11. On this page, they can see the list of publishing destinations currently present in the project. This list also displays an FTP username and password for each publishing destination. With this information, CCCS can return to their content authoring tool and enter the corresponding username and password to Week 13 s section in the source controlled project file. They would then repeat this for the sections for Weeks 2-12, being sure to use the username and password from the Week 2-12 publishing destinations. After this is complete, the connection is made between the content in the source control file and the present invention's functionality for serving the content externally.

Publishing destination type provides for a critical feature in the present invention. This value denotes what type of content is being served through an LTI® link by the present invention. While publishing destinations provide the “where” of the content being served, publishing destination types provide the “what” of the content being served. As mentioned previously, various content authoring tools such as Adobe® Dreamweaver can be used when developing content to be served through the present invention. This enables users of the present invention to use different authoring tools based on their needs, thus dramatically increasing the versatility of the present invention. The actual publishing destination type may be tied to a specific content authoring tool (as described in the next paragraph), or it may be a customized publishing destination type created for a specific client based on style and formatting constraints.

One institution might want to develop their courses in HTML through Adobe® Dreamweaver. A company using the present invention for training, however, might want to use only interactive HTML5 content designed through Articulate® Storyline available from Articulate of NY, N.Y. These two different approaches would produce different files in the respective source control repositories on the source control server 38. The present invention must know what type of file is present so that it can correctly process the information located in the source control server 38 through a publishing destination and into an LTI® link. Returning to the CCCS example, the college or a user may wish to use MadCap Flare available from MadCap Software, Inc. of La Jolla, Calif., to produce HTML5 files of their course content. When creating the 12 publishing destinations for their JUGL 101 course as described in the paragraph above, CCCS has the option of selecting a publishing destination type. At the Add Publishing Destination screen, FIG. 11, the user would select the “Flare” option from the dropdown list provided by the present invention. Upon creation of the publishing destination, the present invention would then know that files within this publishing destination should be treated as Flare files. It would then be able to access the correct code to parse such files during the presentation process.

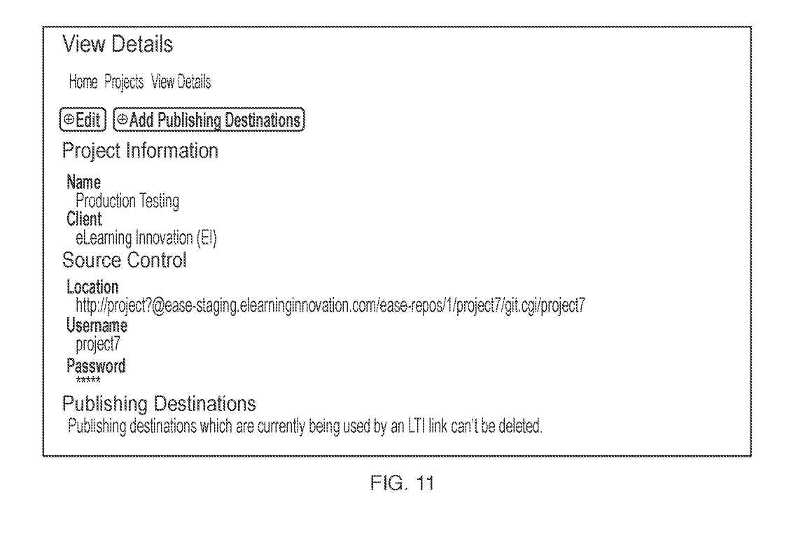

The second major part of content service through the present invention is an LTI® link. As mentioned previously, LTI® stands for Learning Tools Interoperability®. It is a universal standard among Learning Management Systems (LMSs) such as Moodie® or Blackboard®, which means that the present invention can easily present content through nearly any learning management system used to provide online education. Organizationally, LTI® links are managed in their own section of the present invention; upon creation (see FIG. 12A), they are then associated with a project and publishing destination (See FIG. 12B). Once that association is established, when deployed in an LMS 36, the LTI® link will have access to the correct content to serve to the user.

Again, the example of CCCS helps demonstrate this functionality. Thus far, CCCS has created their project within the present invention for the JUGL 101 course as part of their Circus Performance degree program. They have also created a publishing destination for each week of the course content, of which there are 12. To actually finish the process, however, and get the content to instructors and students in the online environment, they must create LTI® links. To do this, a CCCS user logs into the present invention, and selects LTI® Links from the main navigation page. When brought to the LTI® links screen (FIG. 12B), CCCS users will be able to view LTI® links already in the system, select the number of pre-existing links to display, and search/filter based on the LTI® link number or publishing destination. For each LTI® link displayed on this screen, users can see the LTI® link ID number, consumer key, shared secret, and project; they can also edit, delete, and disable/enable each LTI® link (see FIG. 12B). These functions are explained below.

CCCS will also have the ability to add an LTI® link. CCCS would use this feature to add LTI® links for their courses. Because JUGL 101 has 12 different publishing destinations (one for each week of the course), CCCS would need an LTI® link for each publishing destination. CCCS would click to add the first LTI® link. When this is clicked, they are presented with 4 fields: consumer key, shared secret, project, and publishing destination (see FIG. 12A). The consumer key and shared secret fields are automatically populated; these two fields provide CCCS with information necessary to publish their content. When entering LTI® links into an LMS, consumer key and shared secret must be entered with the LTI® link URL address. They provide authentication functionality, with consumer key acting as a username and shared secret acting as a password. When the present invention is getting requests to serve LTI® links, it will not do so unless the electronic request for the LTI® link URL contains these two pieces of information. CCCS, then, will take note of the consumer key and shared secret (they can always access them later). They also have the option of editing the text to provide a user selected preferred string of characters for both fields.

The other two fields, project and publishing destination, will need to be filled out by CCCS. Both are drop-down boxes from which CCCS will make the appropriate selections. CCCS first clicks on the drop-down box for project; the list displayed will be all of the projects associated with their client account. They will select the JUGL 101 project. Next CCCS will click the drop-down box for publishing destination. This list will be populated based on the selection in the project field; in this case, all of the existing publishing destinations in the JUGL 101 project will be displayed. This LTI® link is for the first week, so CCCS selects the publishing destination for Week 1. Once these two fields are filled correctly, CCCS clicks the save button.

Once the LTI® link has been created, CCCS will be taken back to the LTI® section of the present invention. There, CCCS can view the LTI® link ID number, consumer key, shared secret, and project; CCCS is also presented with three options: edit, delete, and disable. Clicking edit will return CCCS to a screen similar to the create LTI® link screen; the only difference will be that the consumer key field will not be visible, because this cannot be edited once the LTI® link is created. The shared secret, project, and publishing destinations will all be visible and editable. Clicking save will commit any changes.

The other two options with respect to the LTI® links are delete and disable. Delete will remove the LTI® link from the system permanently. Disable will keep the link in the system, but it will not be active; attempts to have the link display in an LMS will not be successful, but if the user wants to re-activate the LTI® link, it can do so by choosing to “enable” the link. After creating the LTI® link for the Week 1 publishing destination, CCCS would repeat for Weeks 2-12. After this process, each publishing destination in the JUGL 101 project would have an LTI® link available within it.

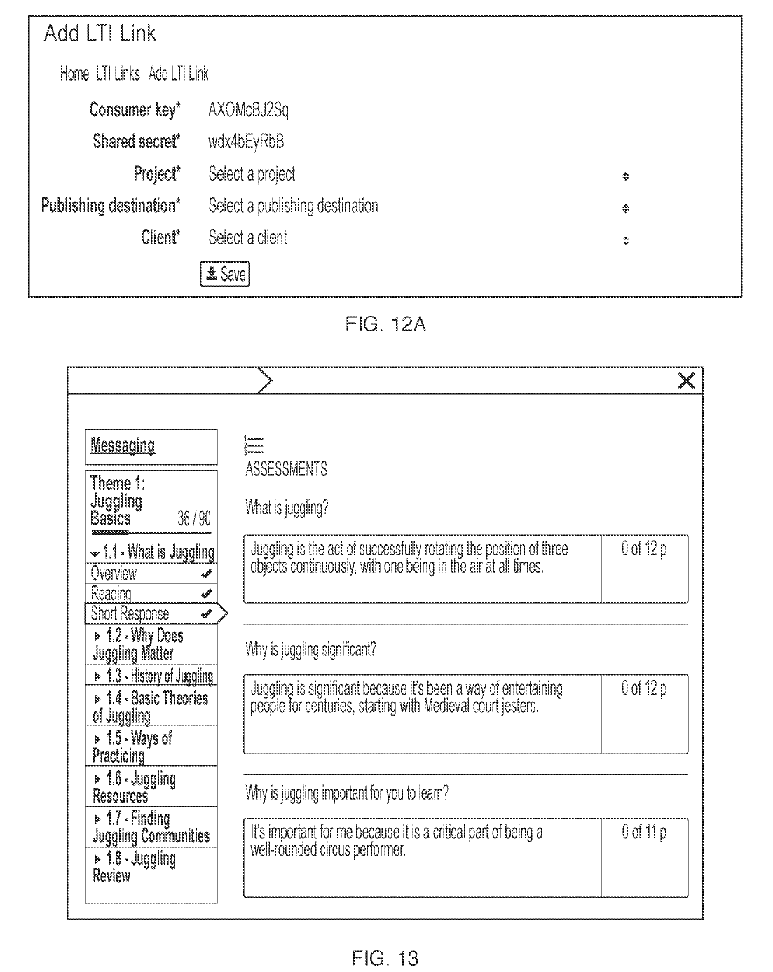

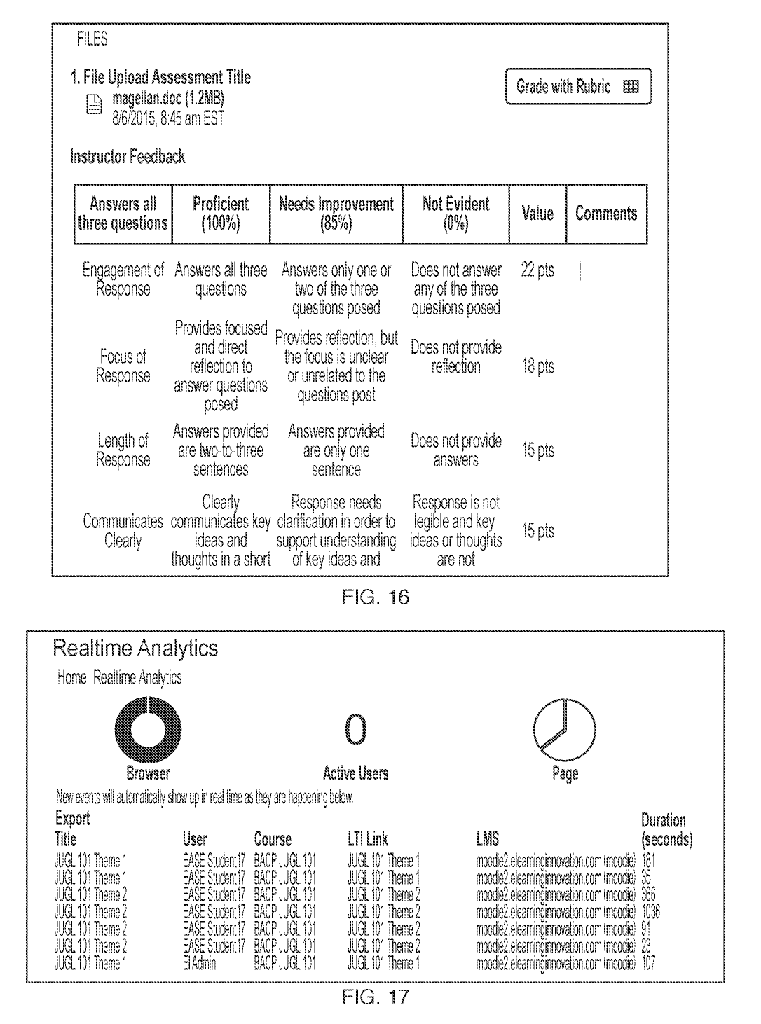

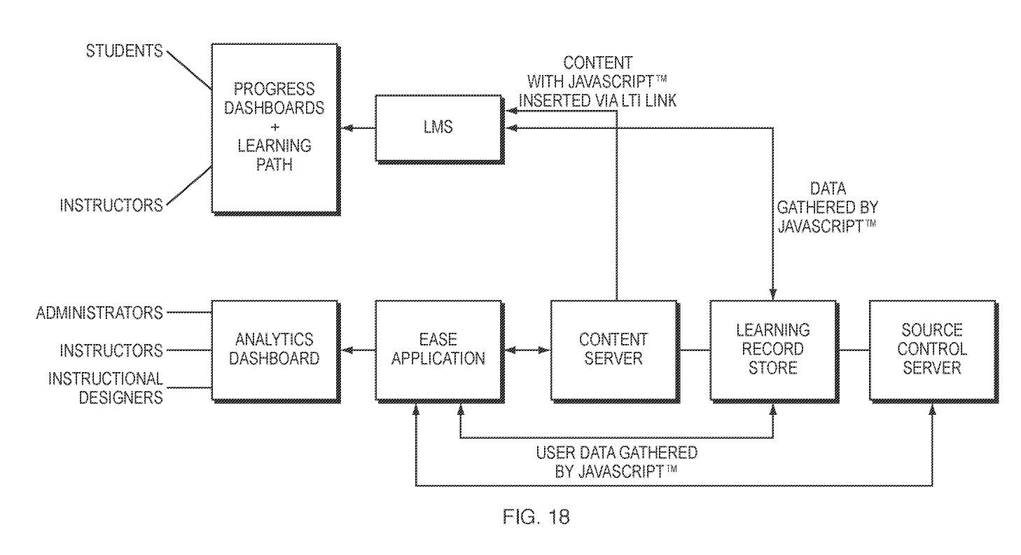

Once the LTI® links are all created, CCCS is ready to deploy their content in an LMS. In this stage, the present invention provides for two critical features: the learning path (including progress dashboards for students and instructors FIGS. 13-16) and data analytics (FIG. 17). Conceptually, the provision of these two features happens as content is served through the present invention via LTI® links. Because LTI® links are presented in HTML, the present invention is able to inject custom JavaScript® code into these pages as they are being served to the end user. This allows the present invention the ability to measure many different data points about the end user's interaction with the content presented to them. Usage data, such as mouse clicks and time on page, can be recorded and displayed. Since the end users also submit assessments that are aligned to outcomes in the system, data regarding their performance in terms of both traditional grades (example, user A got 85% on the final paper assignment) and outcomes (example, user A has demonstrated proficiency on 75% of outcome 1). Because of their contexts, however, there are some differences between the progress dashboards (presented to the end user when the content is served) and the present invention's analytics dashboard (viewed through logging directly into the present invention). FIG. 18 shows the conceptual way in which the present invention was designed to make use of the data collected at different end points.

The progress dashboards are designed for course progress tracking for end users taking online courses using the present invention. Generally, these users will have the role of student or instructor. Students and instructors have different needs for this dashboard. Student will be primarily interested in tracking their own progress, seeing their grades, and getting feedback. Instructors, however, are concerned with monitoring the class as a whole; they will want to have comprehensive views of student performance, access individual student statistics, and give grades and provide feedback on student work. Because LTI® protocol is able to differentiate specific user roles within an LMS, these progress dashboard views can be specialized by user role. This allows for the present invention to serve different versions of the dashboard to meet different users' needs.

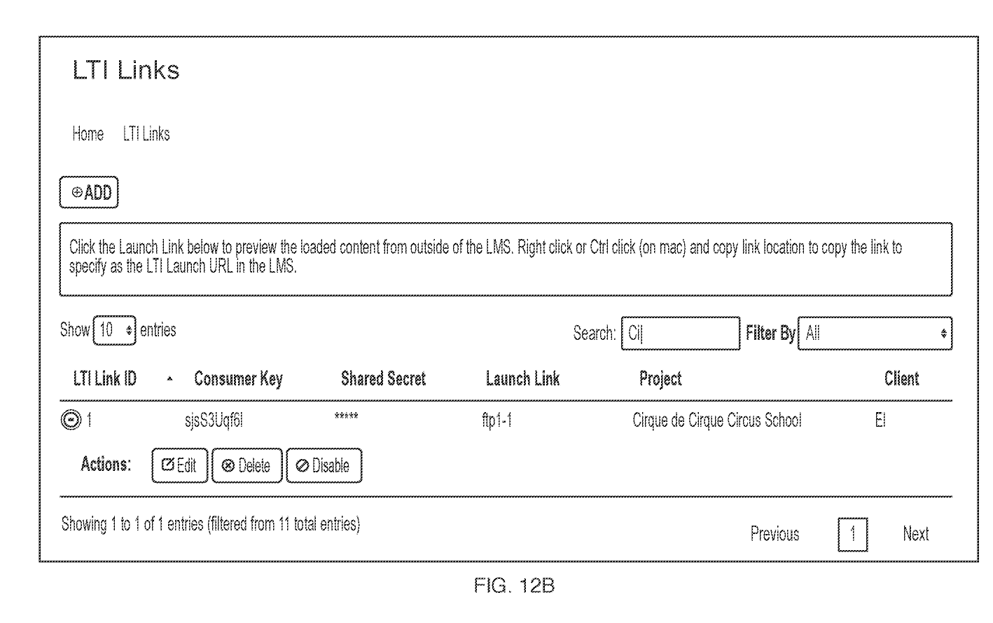

The student version of the progress dashboard has two major components that are viewable from the same screen: student progress on activities and assessments and a course chat (see FIGS. 13 and 14). Students can view the iterative progress that they have made towards completion of the course. This definition of progress can vary; it could be completion of the content areas (week 1, week 2, etc.), assessments, or achievement of outcomes.

Consider the example of CCCS. With their BACP program planned out, the JUGL 101 course content created, and their LMS set-up to use LTI® links to access that content via the present invention, they are now ready to run students through their courses. The term would begin, and students would begin accessing the course content via the LMS and the present invention's Learning Path. While doing this, they would be reading educational materials linked to the content, watching videos, and completing assessments. The purpose of the student progress dashboard is to give students an overview of what progress they have made in the class given all of these activities. Students are able to access this progress dashboard from the Learning Path. For an example of this dashboard, see FIG. 13. This dashboard is presented by LTI® to the LMS via the present invention; essentially, it is a display of fields saved on a per-student basis in the database. Using the user role field of LTI®, the present invention knows the role of the user viewing the progress dashboard and knows the user account. With this information, the present invention is able to display the information relevant to only that student.

FIG. 13 shows the different activities in the course in the left-hand column. If the activity is just for completion (such as watching a video) a check will appear when it is complete. If it is an assessment for a grade, the student is able to see the grade in that left-hand column once completed and graded. The student is also able to click on assessments in that left-hand column to see a more detailed view in the middle of the screen (as in FIG. 13). In this detailed view, students are able to see a copy of the assessment they submitted, which is accessible from the tab on the left in that middle section. In this area, they will also have the ability to access instructor feedback on their assessment performance. They are able to see any helpful remediation files or support resources uploaded by the instructor in the middle tab. And, finally, students are able to see a breakdown of their score from the right tab in rubric format if there is a rubric associated with the assessment.

The other major functionality of the student dashboard is located at the top of the left-hand navigation column. Clicking the course name located there will display an ongoing course chat between the student and the instructor. See FIG. 14. Here, students will be able to get answers to their questions about the materials from instructors and instructors will be able to explain feedback and give performance tips.

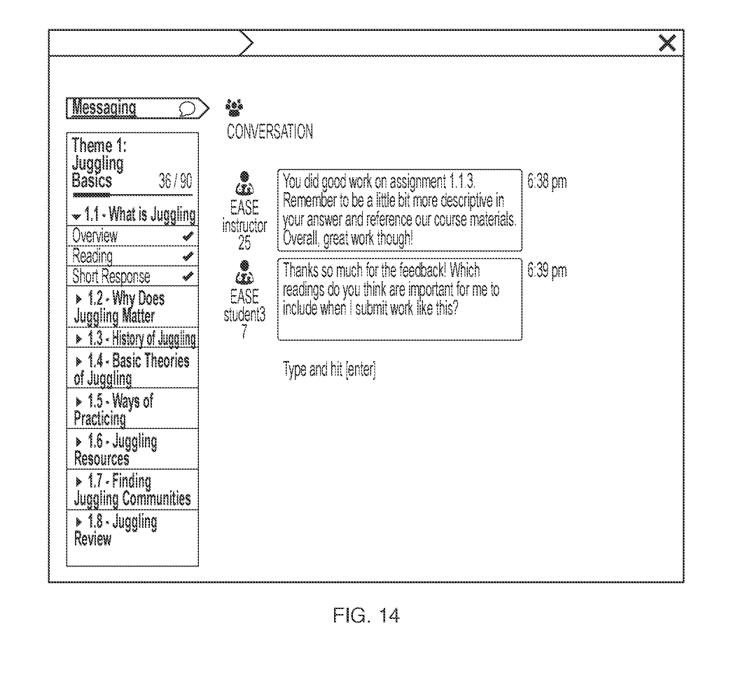

If the role of the user is instructor, the present invention will present a different version of this dashboard. The instructor progress dashboard mirrors the functionality of the student dashboard with some differences, see FIG. 15. The instructor can see, on a per-student basis, almost the exact same view as the student. Using the scroll feature and drop-down box, however, the instructor can navigate from one student to another. This allows the instructor to easily access in-depth information about each student as needed. The instructor can also access the course chat for each student from the instructor progress dashboard.

The primary way that the instructor progress dashboard functions differently from the student progress dashboard is the instructor's ability to grade and give feedback on student assessments. When a student submits an assessment, it is saved in the system in the learning record store 43. An ungraded assessment causes a notification to the instructor that there is ungraded work. To grade the assessment, the instructor accesses the dashboard. Unlike students, instructors have a quick way to navigate from student to student, via a drop-down menu or back-and-forth button (see FIG. 15). Using these functions, the instructor can quickly navigate among the students, grading work and giving feedback.

For example, consider the example of CCCS's BACP degree. With the content designed in the present invention being served to CCCS's online LMS using LTI®, students are able to interact with the content. In module 10, there are two assessments: a quick quiz about juggling knowledge and the three-ball juggling assessment, described earlier, which uses a rubric for grading. These assessments illustrate the two ways instructors will grade and give feedback: through the assessments designator on the dashboard or through a rubric. See FIG. 15.

The quiz is short, and consists of 5 questions: 4 multiple choice and 1 short answer. When a student takes the quiz in the learning path, the student attempt at this quiz is saved in the learning record store database 43. When the instructor accesses the dashboard for this student attempt, the quiz will appear on the assessment tab. When displayed, the instructor will see the four multiple choice questions; because they have a definable answer when created in the assessment generator, the correct option is indicated. When displayed, the present invention will automatically assign full points for the correct answer (or 0 points for an incorrect answer) in the box to the right of the question (see FIG. 15). The instructor does have the ability to manually override the assigned point value. The short answer question, however, will not be automatically graded because answers can vary. Thus, no points will be automatically assigned to this question; the instructor will review the answer and assign a number of points in the box to the right of the question/answer based on the completeness and accuracy of the student's answer. The instructor also has the ability to add a comment for every question to give the student feedback for improvement. Similarly, any assessment that does not require a rubric will be graded on this screen. For all types of assessments other than quiz/test, this screen will display a field that the instructor can update for total points and a link/display of any relevant answers or files submitted by the student.

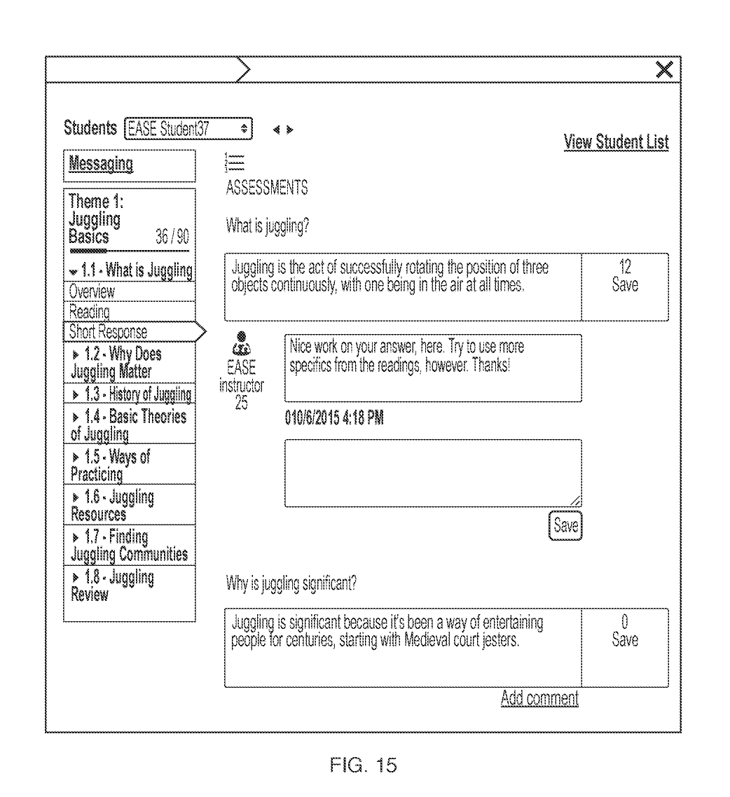

Many assessments will need to be graded with a rubric, such as the case with the three-ball juggling assessment for JUGL 101. When an assessment is created and a rubric is associated with it, a “grade with rubric” button will appear on the assessments tab in addition to a total points field and any work completed by the student. See FIG. 16. After viewing the assessment, the instructor can click this button to access the rubric. When clicked, it will bring up the rubric for the assessment, along with a potential of two fields: comments to student and points value. Note that the points value field will not appear if the assessment is not being counted for a numerical grade value (such as in a competency-only education model).

To grade the assessment using the rubric, the instructor does three things: selects the performance level that the student met for each demonstration criteria, assigns a point value (if applicable), and adds a comment for feedback. For CCCS's JUGL 101 three-ball juggling assessment, the instructor would be grading a student based on four criteria: Hand Scoop, Ball Toss, Throw and Catch, and Audience Engagement. Starting with Hand Scoop, the instructor would first decide if the student was proficient, needs improvement, or not evident in this category. The level selected would denote the value of the outcome mapping achieved by the student. In this example, proficient is worth 100%, needs improvement is worth 70%, and not evident is worth 0%, and the total value of this outcome mapping is 25% of Course Outcome 1. If the student is graded as proficient, the student will have met 25% of that course outcome. If needs improvement is assigned, then the student will have met 17.5% of that outcome (25×0.7=17.5). If not evident is assigned, the student will have met 0% of that outcome.

After determining the performance level, the instructor can assign a point value (if applicable). For the JUGL 101 example, the total assignment is worth 100 points in terms of grade. Each demonstration criterion (Hand Scoop, Ball Toss, Throw and Catch, Audience Engagement) is evenly weighted, at 25 points each. Based on performance, the instructor would then determine the point value, out of 25, for each criterion. It should be noted that while the points assigned by grade should generally align with the performance level assigned, this field provides the instructor the ability to assign points within a range. For example, the instructor may have assigned a performance level of needs improvement for Hand Scoop. While the point value given should not be the full 25, the instructor may feel that the student was on the upper end of needs improvement. Thus, instead of 17.5 points for this value (which is 70% of 25), the instructor could assign 20 points. This affords some level of flexibility in grading.

Finally, once performance level and points value are determined, the instructor has the ability to insert feedback in the comments field. This feature enables the instructor to explain why a certain level was achieved/not achieved and to provide advice for improvement.

The analytics dashboard porting of the present invention is shown in FIG. 17. While the progress dashboards are presented to the student and instructors in the course content via LTI®, the analytics dashboard is accessed by directly logging into the present invention through a web browser. It can be viewed by clicking the “Realtime Analytics” option from the home page after logging in. Note that the figure seen is only representative of what the analytics dashboard could look like. By its nature, this area is highly customizable in order to meet the varying needs of potential institutions or businesses. This customization comes from the design of the present invention. Using a custom-built data API, the present invention is able to gather and display data from the student and instructor interactions in the content from the learning record store 43. As discussed previously, the present invention has the ability to insert JavaScript® code into the content when it is presented to the LMS. The JavaScript® code feeds the information gathered from the instructor-student interactions back to the present invention via the data API. This functionality is what gives the analytics dashboard the ability to display customizable, real-time content. This type of information is most beneficial for the administrators of the institution or company leaders, because it provides large-scale data about usage and performance that can be critical in making decisions about their online learning program.

Returning to the example of CCCS, the school decides that they want to monitor the average amount of time spent by students in each module, their average performance in terms of grade, and the rate of submission for the three-ball juggling assessment. By configuring the analytics dashboard for CCCS correctly, this information can be displayed. The JavaScript® code inserted into the LTI® links can measure the active time spent in the course content by each student. This information would be fed back (over a secured connection) to the data API of the present invention. There it would be aggregated and then displayed to the viewers of the dashboard. Similarly, the present invention would also know the total grades for all users currently taking the course. This data would be received by the data API, aggregated and averaged out, and displayed to the viewers of the dashboard. Because the present invention knows the number of students in the class and stores the assessment information in its learning record store database 43, it would be able to display the submission rate for the three-ball juggling assessment based on the number of assessments in the database, divided by the total number of students in the course.

These three simple data points illustrate the flexibility of the present invention's analytics dashboard. Additionally, the present invention can archive reports as needed for future reference. This allows for analysis of trends over time, which can aid in making decisions about curriculum revisions/development, enrollment, and other critical factors related to course success.

Accordingly, the present invention provides for a novel and non-obvious system and method for use in the field of online learning to design, deliver, measure, track, and manage educational courses and programs thereby improving the quality and consistency of online course delivery and providing critical analytics to administrators. The system and method are implemented as an integrated suite of web applications operable on a computer processor configured and designed to allow a user of a computerized system operating such web applications to design, deliver, measure, and manage educational content. The system and method of the invention provides for a number of necessary functionalities in this process, including source control service, content service, curriculum mapping, assessment/rubric generation, stylized content experience for learners and instructors (learning path), and data analytics for learners, instructors, and administrators.

Modifications and substitutions by one of ordinary skill in the art are considered to be within the scope of the present invention, which is not to be limited except by the allowed claims and their legal equivalents.

What is claimed:

1. A computer-implemented system for providing a remote competency-based assessment, comprising:
an object-oriented learning structure, having a learning outcome;
a learning module, having a module outcome, the module outcome including an assessable competency-based requirement;
a learning program database having an interface, accessible through a web browser, configured for defining and manipulating a relationship between the learning module and the learning outcome, the relationship being manipulated visually through the web browser;
the interface being further configured for authoring content related to the competency-based requirement, for assessing completion of the competency-based requirement, for reviewing a progress of the competency-based requirement, and for tracking progress towards the learning outcome; and
the interface providing an aggregate progress report for multiple users participating in multiple learning modules.

2. The system of claim 1, wherein the interface comprises a third-party Learning Management System.

3. The system of claim 1, wherein the learning outcome can only be completed after all learning modules associated with the learning outcome have been completed.

4. The system of claim 1, wherein the interface comprises a library of objects representing learning outcomes, learning modules, and module outcomes, such that a drag-and-drop function of the objects creates the relationship between the learning module and the learning outcome.

5. The system of claim 1, wherein the learning program database contains a learning structure template, which can then be customized through the interface.

6. The system of claim 1, wherein the learning program database comprises a content source control database, the content source control database storing the content related to the competency-based requirement with version tracking.

7. The system of claim 1, wherein the computer-implemented system is responsive to non-transitory computer system operating instructions stored on a storage medium remote from the computer-implemented system, the storage medium coupled to the computer-implemented system by the internet.

8. The system of claim 1, further comprising an API for receiving data from third-party software systems used for reporting analytics.

9. The system of claim 1, wherein the competency-based requirement comprises objective assessment testing information and/or rubric-based testing information.

10. The system of claim 1, wherein the competency-based requirement comprises a multiple-choice test.

11. The system of claim 1, wherein the competency-based requirement comprises viewing a video.

12. A computer-implemented method for providing a remote competency-based assessment, comprising:
providing an object-oriented learning structure having a learning outcome;
providing a learning module having a module outcome, the module outcome including an assessable competency-based requirement;
providing a learning program database having an interface, accessible through a web browser;
defining and manipulating a relationship between the learning module and the learning outcome, the relationship being manipulated visually with the interface through the web browser;
authoring content related to the competency-based requirement with the interface;
assessing completion of the competency-based requirement with the interface;
reviewing a progress of the competency-based requirement with the interface;
tracking progress towards the learning outcome with the interface;
providing an aggregate progress report for multiple users participating in multiple learning modules with the interface.

13. The method of claim 15, wherein the defining and manipulating comprises dragging and dropping objects from a library of objects representing learning outcomes, learning modules, and module outcomes to create the relationship between the learning module and the learning outcome.

14. A computer-implemented system for providing a remote competency-based assessment, comprising:
a database storing a user defined learning structure;
an interface, accessible through a web browser, receiving and storing a learning outcome in the database;
the interface receiving and storing a learning module in the database, the learning module having a module outcome, the module outcome including an assessable competency-based requirement;
the interface configured for defining and manipulating a relationship between the learning module and the learning outcome, the relationship being manipulated visually through the web browser;
the interface receiving user defined module outcome content, including the assessable competency-based requirement, storing the content in the database, and associating the content with a corresponding module outcome;
the interface receiving user defined module outcome testing information, storing the testing information in the database, and associating the testing information with a corresponding module outcome;
the database storing learning program completion information for a remote user relating to completion of one or more learning outcomes, including the remote user's completion of module outcome content and module outcome testing information;
the interface providing the remote user with module outcome content and module outcome testing information based upon the learning program completion information;
wherein each learning module can only be completed after all associated module outcomes are completed.

15. The system of claim 14, wherein the interface comprises a library of objects representing learning outcomes, learning modules, and module outcomes, such that a drag-and-drop function of the objects creates the relationship between the learning module and the learning outcome.

16. The system of claim 14, wherein in the learning program completion information module outcomes are weighted with a percentage such that a first module outcome has a higher percentage than a second module outcome.
